(19) United States
(12) Patent Application Publication
(10) Pub. No.: US 2014/0027656 A1
(43) Pub. Date: Jan. 30, 2014

(54) Connector

(71) Applicant: Tyco Electronics Japan G.K., Kanagawa-ken (JP)

(72) Inventors: Shinji Yamada, Kanagawa (JP); Takashi Shimoyasu, Kanagawa (JP); Kenji Kiyota, Koshi City (JP)

(73) Assignee: Tyco Electronics Japan G.K., Kanagawa-ken (JP)

(21) Appl. No.: 13/949,716

(22) Filed: Jul. 24, 2013

(30) Foreign Application Priority Data
Jul. 25, 2012 (JP) 2012164652

(51) Int. Cl. H04B 10/80

(52) U.S. Cl. CPC H04B 10/802
USPC 250/551

(57) ABSTRACT

A connector is provided that includes a housing and an electronic circuit. The housing includes a mating section with a mating contact, a mounting section having a circuit board contact, and a circuit receiving space positioned along an inner surface thereof. The electronic circuit is positioned in the circuit receiving space and connects to both of the mating contact and the circuit board contact. The electronic circuit includes a photocoupler which electrically insulates the mating contact and the circuit board contact from each other and relays a signal in an optical manner.

### CROSS-REFERENCE TO RELATED APPLICATIONS

This application claims the benefit of the filing date under 35 U.S.C. §119(a)-(d) of Japanese Patent Application No. 2012-164652 of Jul. 25, 2012.

### FIELD OF THE INVENTION

The invention relates to an electrical connector and, more particularly, to a connector to be mounted on a circuit board and mate with a mating connector.

### BACKGROUND

There are known connectors that mounted on a circuit board and mates with a mating connector to connect between the mating connector outside the circuit board and an electronic circuit on the circuit board. Among such circuit boards having known connectors, there is a circuit board configured to receive an electric signal transmitted through a photocoupler (opto-isolator) using a known connector to insulate and transmit the electronic signal to a next circuit on the circuit board. By applying this configuration, possibilities of malfunctions or failures in an electronic circuit on the circuit board by noise from the outside are reduced because of being electrically isolated from the outside by the photocoupler. In addition, the electronic circuit on the circuit board may be operated with a power supply voltage different from that of the outside. However, in such configuration, the photocoupler, which does not provide signal processing, is required to be mounted on the circuit board. For this reason, specifically in a configuration in which the number of signal lines is large, photocouplers whose count is consistent with the number of signal lines require a large area on the circuit board. In such a case, an area for arrangement of electronic components for signal processing is constrained.

Japanese Patent Publication JP 2005-191139A and Japanese Patent Publication JP 2005-268009A disclose known connectors, each having a configuration in which a signal transmitted from a mating connector is processed by electronic components mounted inside and the processed signal is outputted again to the mating connector.

### SUMMARY

In view of the foregoing, the present invention has been made to provide a connector having a housing and an electronic circuit with a photocoupler. The housing includes a mating section with a mating contact, a mounting section having a circuit board contact, and a circuit receiving space positioned along an inner surface thereof. The electronic circuit is positioned in the circuit receiving space and connects to both of the mating contact and the circuit board contact. The photocoupler electrically insulates the mating contact and the circuit board contact from each other and relays a signal in an optical manner.

### BRIEF DESCRIPTION OF THE DRAWINGS

The objects, features and advantages of the invention will become more apparent by describing in detail embodiments thereof with reference to the accompanying drawings, in which:

FIG. 1 is a perspective view of a connector according to the invention;

FIG. 2 is a sectional view of the connector in FIG. 1 taken along the line X-X;

FIG. 3 is an exploded perspective view of the connector in FIG. 1;

FIG. 4 is a perspective view another connector according to the invention;

FIG. 5 is a perspective sectional view of the connector in FIG. 4 taken along the line X-X;

FIG. 6 is another sectional view taken along the line X-X illustrated in FIG. 4;

FIG. 7 is an exploded perspective view of the connector shown in FIG. 4;

FIG. 8 is a perspective view of internal circuits included in the connector shown in FIG. 4;

FIG. 9 is a side view of the internal circuits of the connector shown in FIG. 4;

FIG. 10 is a perspective view of another connector according to the invention;

FIG. 11 is a side view of the connector shown in FIG. 10;

FIG. 12 is a sectional perspective view of the connector shown in FIG. 10 taken along the line X-X;

FIG. 13 is another sectional view of the connector in FIG. 10 taken along the line X-X;

FIG. 14 is a perspective view of another connector according to the invention;

FIG. 15 is a sectional view of the connector in FIG. 14 taken along the line X-X.

FIG. 16 is a perspective view of a housing for the connector shown in FIG. 14; and

FIG. 17 is a sectional view of the housing shown in FIG. 16 taken along the line X-X.

### DETAILED DESCRIPTION OF THE EMBODIMENT(S)

Hereinafter, embodiments of the present invention will be described with reference to the drawings.

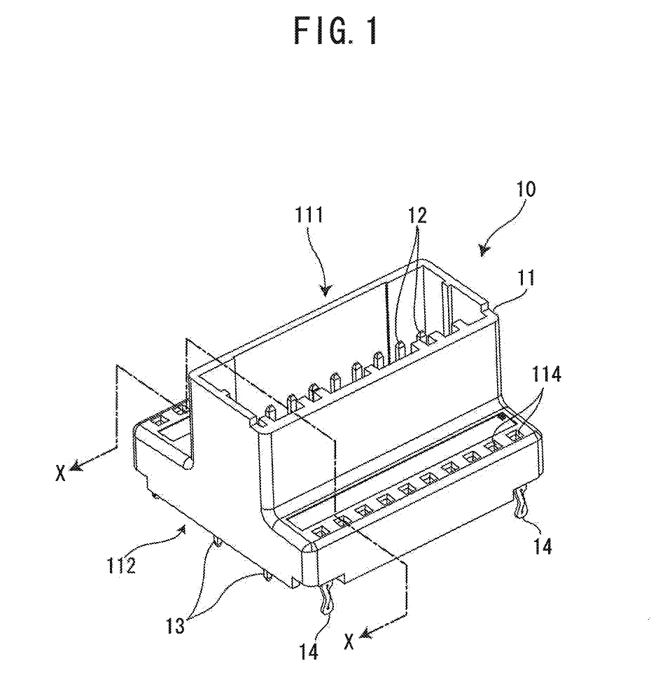

Now, with reference to FIGS. 1-3, a connector 10 according to the invention is shown and includes a housing 11, a plurality of first contacts 12 which are arranged in two rows and a plurality of second contacts 13 which are similarly arranged in two rows with respect to the plurality of first contacts.

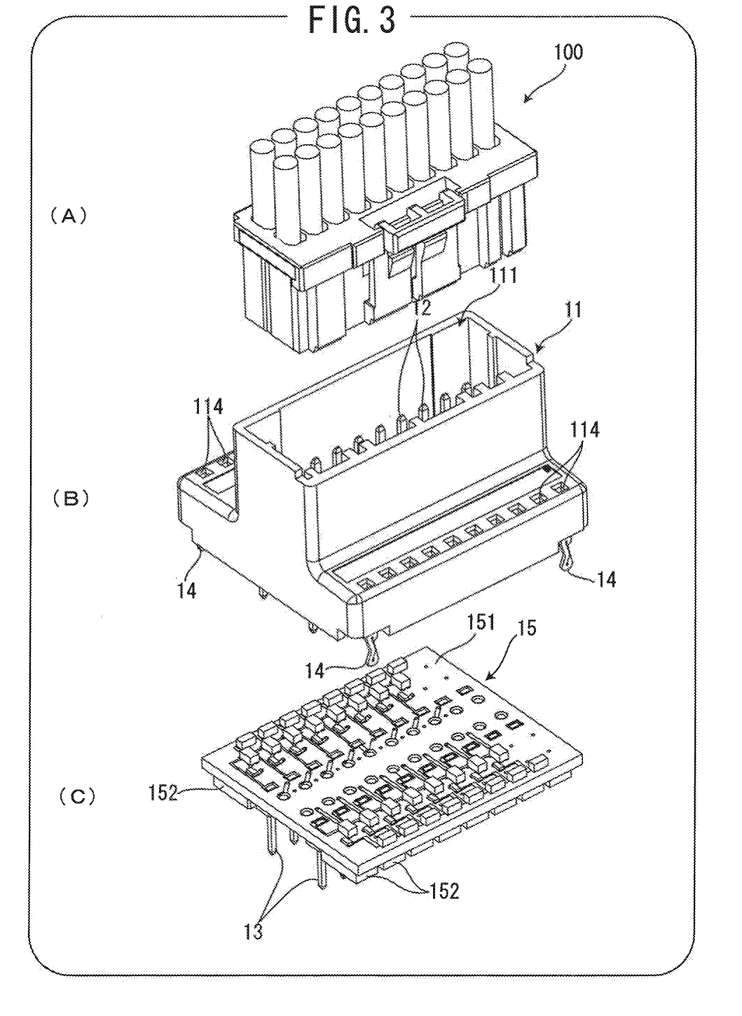

The housing 11 includes a mating section 111 and a mounting section 112. The mating section 111 is an element of the housing 11 that mates with a mating connector 100 (see part (A) of FIG. 3). The first contacts 12 are disposed in the mating section 111, and make contact with contacts (not shown) of the mating connector 100 when being mated with the mating connector 100. In addition, the mounting section 112 connects the housing 11 to a circuit board (not shown). The second contacts 13 are disposed in the mounting section 112. The second contacts 13 are positioned through contact receiving passageways that are disposed on the circuit board to penetrate from a top surface to a bottom surface, and the second contacts 13 are soldered to the circuit board on a bottom surface thereof. In addition, the mounting section 112 includes solder pegs 14. The solder pegs 14 pass through receiving passageways of the circuit board and are soldered, so that the connector 10 is positioned and fixed to the circuit board

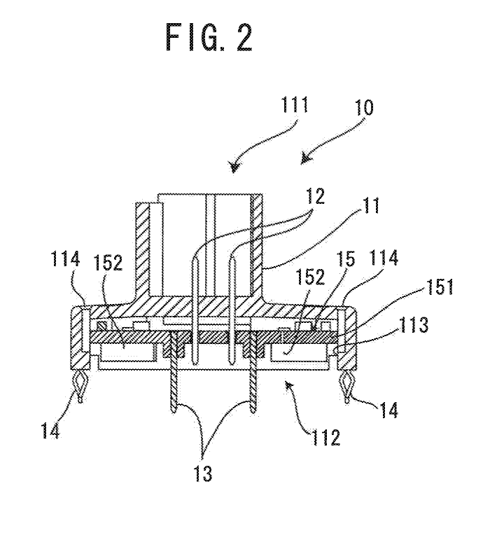

In addition, as shown in FIG. 2, a circuit receiving space 113 is formed on a side facing the circuit board in the housing 11. An internal circuit 15 shown in part (C) of FIG. 3 is positioned to face the circuit board in the circuit receiving space 113. The circuit receiving space 113 is formed in a shape such that the housing 11 forming the circuit receiving space 113 covers the internal circuit 15 in combination with the circuit board on which the connector 10 is to be mounted. Incidentally, such a configuration may be used that a side on the mounting section 112 (a bottom side) of the circuit receiving space 113 is closed by a part of the housing, such as a lid included in the housing, to cover the internal circuit 15 when positioned in the circuit receiving space 113 without depending on the circuit board.

In the shown embodiment, the internal circuit 15 positioned in the circuit receiving space 113 is a MID (Molded Interconnect Device). In other words, the internal circuit 15 is a circuit component on which terminals, wiring patterns, electrical components and the like are mounted on a resin molded body. Photocouplers 152 and other electronic components are mounted on a resin molded body 151 in the internal circuit 15. The first contacts 12 and the second contacts 13 each are connected to the resin molded body 151. The first contacts 12 and the second contacts 13 are connected directly or using other electronic components to the photocouplers 152 mounted on the resin molded body 151. The photocouplers 152 are circuit elements to electrically insulate the first contacts 12 and the second contacts 13 from each other and relay signals in an optical manner. The photocouplers 152 are provided one for each pair of the first contacts 12 and the second contacts 13.

In addition, ventilation openings 114 are disposed along the housing 11 in order to communicate the circuit receiving space 113 with the outside. The ventilation openings 114 are receiving passageways to allow heat generated by the electronic components such as the photocouplers 152 included in the internal circuit 15 provided in the circuit receiving space 113 to dissipate to the outside.

The ventilation openings 114 are formed such that heat in the circuit receiving space 113 is allowed to dissipate in a direction in which the heat is cleared from the circuit board in a position in which the connector 10 is mounted on the circuit board. The connector 10 mounts on a surface facing upward of the circuit board that is arranged horizontally, while the mating section 111 faces upward, and the ventilation openings 114 are configured to allow heat in the circuit receiving space 113 to dissipate upward.

As described above, the connector 10 is a connector having a configuration in which the connector 10 itself includes the photocouplers 152, and transmits signals while providing insulation between the first contacts 12 and the second contacts 13. For this reason, according to the connector 10, the electrical insulation is provided between the circuit board and the outside. In addition, when the connector 10 is used, since photocouplers are not required to be mounted on the circuit board, it is possible to have an area of the circuit board available for a variety of uses.

In addition, since the above-described ventilation openings 114 are formed in the housing 11 of the connector 10, heat accumulating in the circuit receiving space 113 may be relieved and thus deterioration of signal transmission accuracy is averted. Additionally, such a design averts components degradation due to the photocouplers 152 and the like.

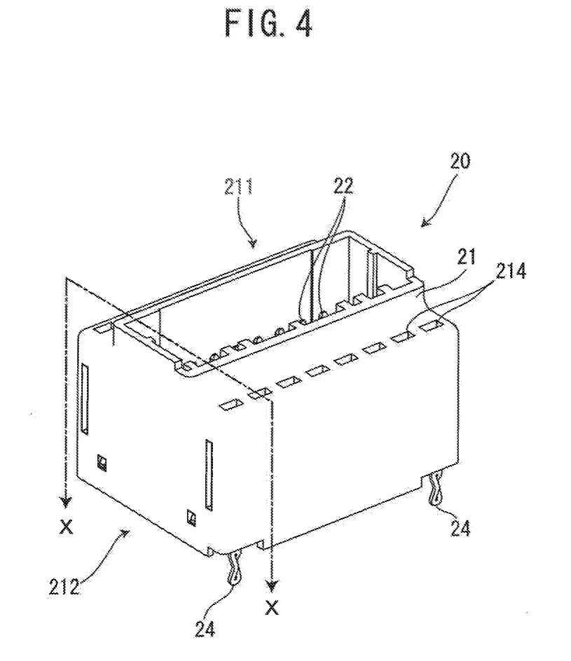

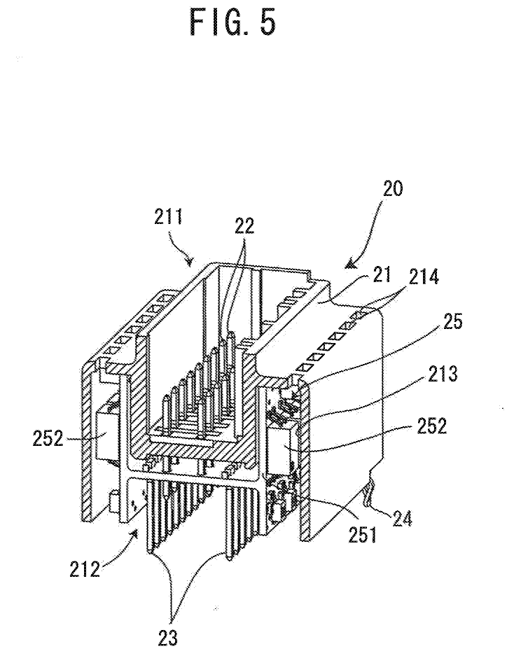

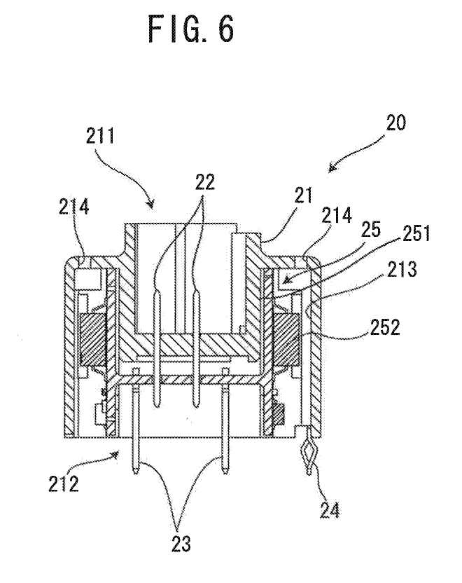

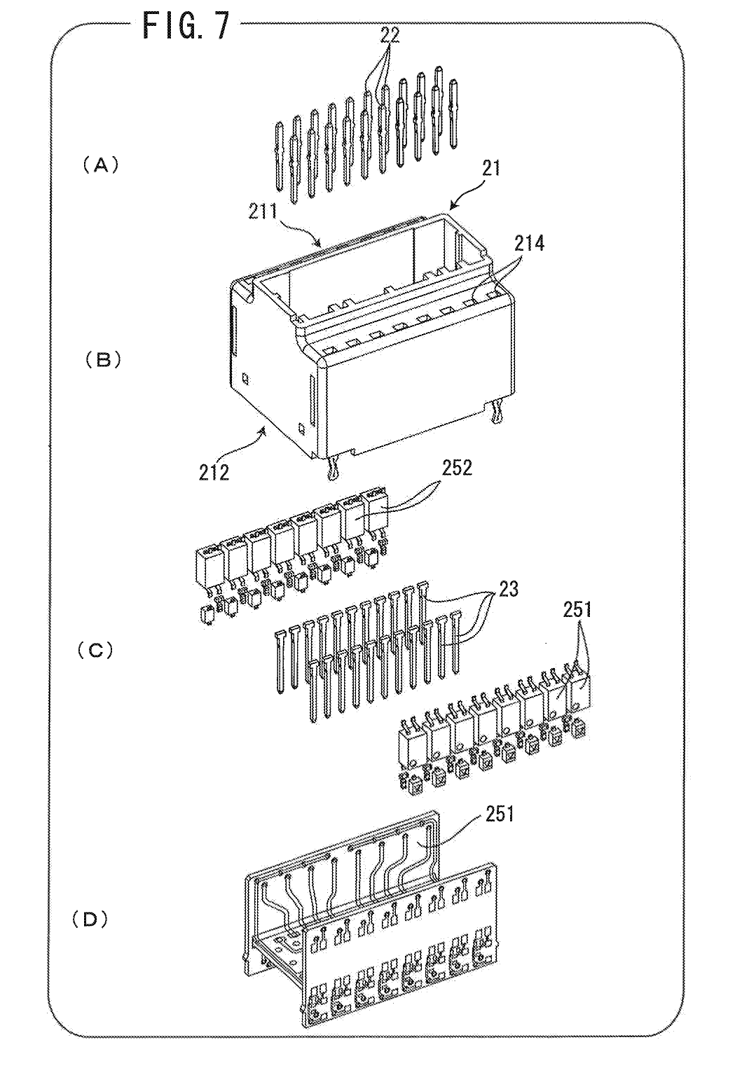

Now with reference to FIGS. 4 through 9, another connector 20 according to the invention will be described. Similar to the above-described connector 10, the connector 20 includes a housing 21, a plurality of first contacts 22 which are arranged in two rows, and a plurality of second contacts 23 which are similarly arranged in two rows.

The housing 21 includes a mating section 211 and a mounting section 212. The mating section 211 has a shape similar to that of the mating section 111, and is used mate with the mating connector 100 having the shape shown in part (A) of FIG. 3.

The first contacts 22 are disposed in the mating section 211, and make contact with contacts of the mating connector 100 when being mated with the mating connector 100.

In addition, the mounting section 212 connects the housing 11 to a circuit board (not shown). The second contacts 23 are disposed in the mounting section 212, and pass through contact receiving passageways that are disposed along the circuit board, and are soldered to the circuit board on a side of a bottom surface thereof. In addition, also similar to the connector 10, the mounting section 212 is provided with solder pegs 24. The solder pegs 24 pass through receiving passageways of the circuit board and are soldered so that the connector 20 is secured to the circuit board.

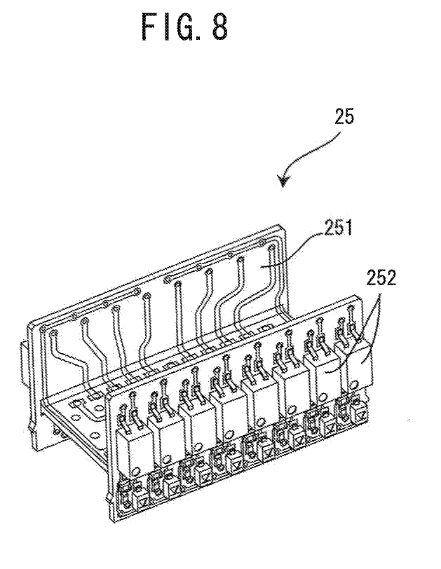

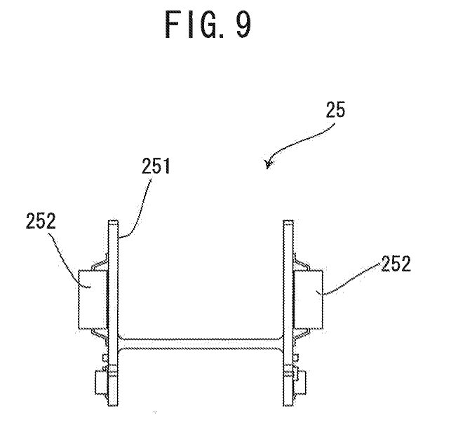

In addition, a circuit receiving space 213 is disposed along a side of the mounting section 212 that faces the circuit board in the housing 21, and an internal circuit 25 having a shape shown in FIGS. 8 and 9 and positioned in the circuit receiving space 213.

The circuit receiving space 213, in which the internal circuit 25 is positioned, has a configuration such that the housing 21 covers the internal circuit 25 in combination with the circuit board on which the connector 20 is mounted. However, also similar to the descriptions of the above-described connector 10, such a configuration may be used that the internal circuit 25 is covered without depending on the circuit board.

In the shown embodiment, the internal circuit 25 positioned in the circuit receiving space 213 is a MID, and as shown in FIG. 9. The photocouplers 252 and other electronic components are mounted on side surfaces of a resin molded body 251 having a sectional shape of H. The side surfaces on which the photocouplers 252 and the like are mounted of the resin molded body 251 are surfaces which extend orthogonal with respect to the circuit board when the connector 20 is mounted on the circuit board.

The second contacts 23 pass through the resin molded body 251 and are secured to the resin molded body 251, and in addition, the first contacts 22 are also passed through to be fixed to the resin molded body 251. The photocouplers 252 and other electronic components are provided one for each pair of the first contacts 22 and the second contacts 23. The first contacts 22 and the second contacts 23 are directly connected directly or using other electronic components to the respective photocouplers 252. The photocouplers 252 are circuit elements to electrically insulate the first contacts 22 and the second contacts 23 from each other and optically relay signals.

In addition, ventilation openings 214 are provided to vent the circuit receiving space 213 in which the internal circuit 25 is arranged, and extend away from the circuit board. The ventilation openings 214 allow heat generated by the photocouplers 152 and the like in the internal circuit 15 to dissipate.

Similar to the above-described connector 10, the connector 20 includes photocouplers 252, and transmits signals while providing electrical insulation between the first contacts 22 and the second contacts 23. Thus, according to the connector 20, since the photocouplers are not required to be mounted on the circuit board, it is possible to allow an area of the circuit board available of wide and effective use.

In addition, the connector 20 differs from the connector 10, in that the connector 20 includes photocouplers 252 that are mounted on the side surface that extend orthogonal to with respect to the circuit board. For this reason, a projected area thereof on the circuit board is reduced and thus it is possible to allow the area of the circuit board available further more for a wide and effective use.

In addition, similar to the connector 10, since the ventilation openings 214 are formed in the housing 21 of the connector 20, accumulation of heat in the circuit receiving space 213 and is prevented and signal transmission accuracy is assisted. Additionally, component degradation with respect to the photocouplers 252 and the like is averted.

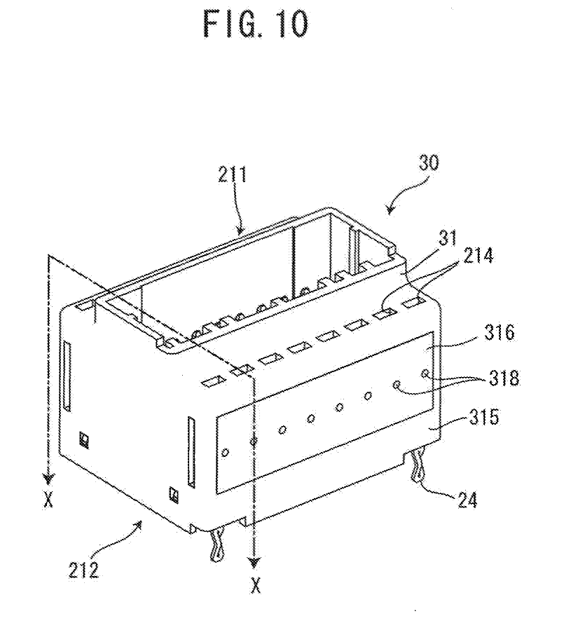

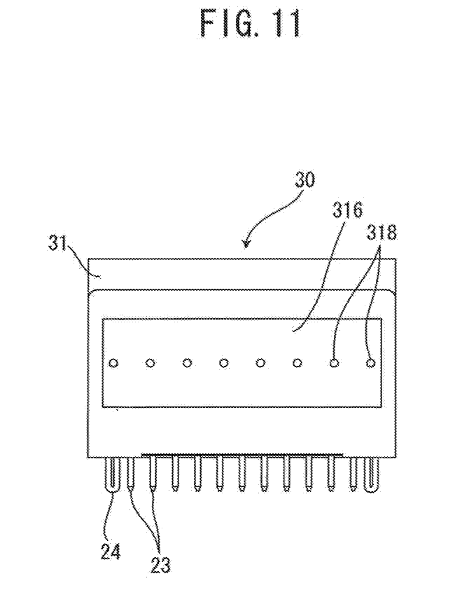

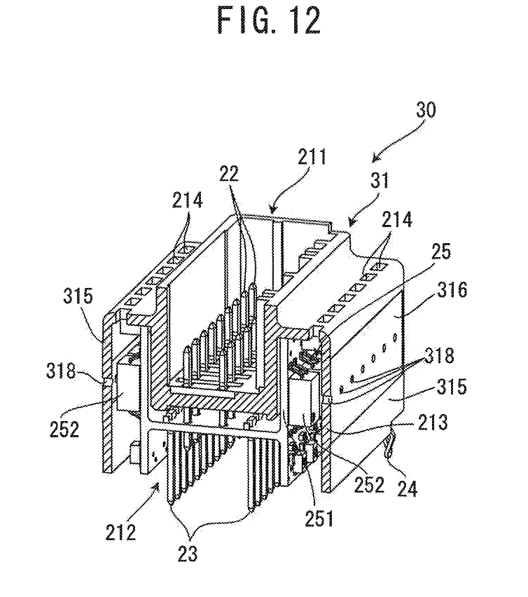

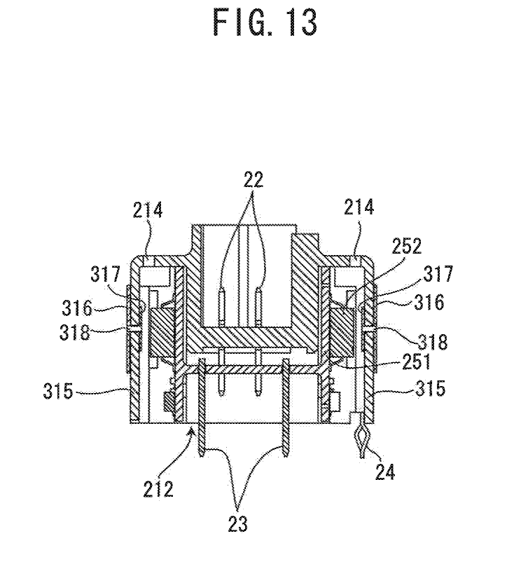

Now with respect to FIGS. 10-13, another connector 30 according to the invention is shown and includes a housing 31 that distinguishes the connector 30 from the connector 20. For the sake of brevity, the housing 31 will be described, and all other elements similar to the connector 20 are denoted using the same reference signs as those used for the connector 20.

In addition, the housing 31 includes elements similar to those of the above-described housing 21 and are denoted using the same reference signs as those used for the housing 21. The differences of the housing 31 from the housing 21 will be described.

The housing 31 includes partition walls 315 on both side surfaces thereof. The partition walls 315 form partial areas of inner wall surfaces defining the circuit receiving space 213 in which the internal circuit 25 is received, and partial areas of outer surfaces defining an external appearance of the connector 30. The partition walls 315 are in the above-described housing 21, however, each of the partition walls 315 of the housing 31 is further formed with metal layers 316, 317 for heat dissipation on an inner wall surface and an outer wall surface thereof. The metal layers 317 extend along surface areas facing the photocouplers included in the internal circuit 25. In addition, the metal layers 316, 317 formed on the inner wall surface and the outer wall surface are connected to each other by metal embedded in openings 318 that pass through the inner wall surfaces and extend into the outer wall surfaces, respectively. In the embodiment shown, the metal layers and the like are formed by the above-described MID. These metal layers 316, 317 transfer heat from the circuit receiving space 213 using the metal layers 316, the metal embedded in the openings 318 of the partition walls 315, and the metal layers 317 on the outer surface sides to dissipate the heat.

Similar to the above-described with respect to the connector 20, the connector 30 also includes ventilation openings 214 for heat dissipation, and therefore, the connector 30 can dissipate heat in the circuit receiving space 213 in two different two ways: (1) ventilation openings 214, and (2) the metal layers 316, 317. Thus, the heat in the circuit receiving space 213 is dissipated more effectively.

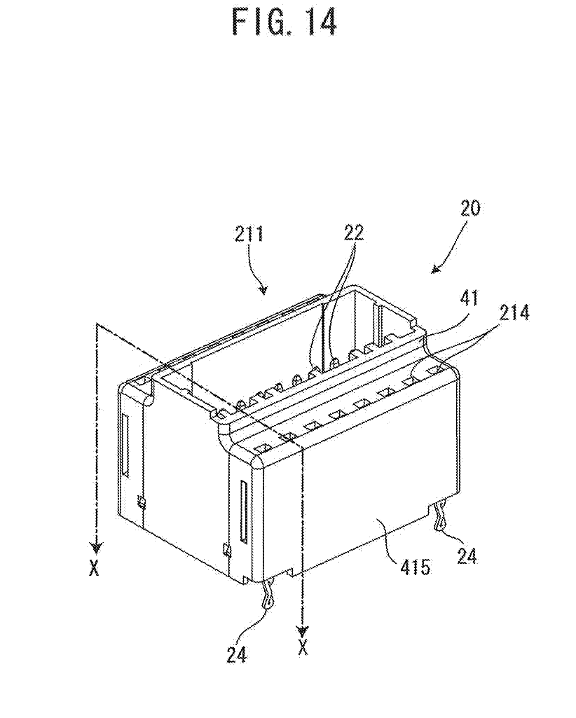

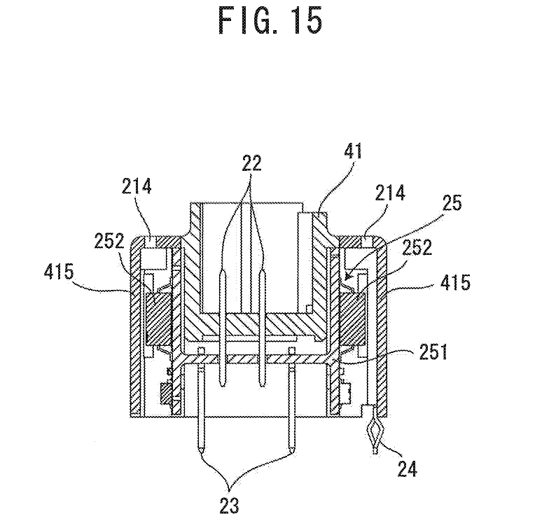

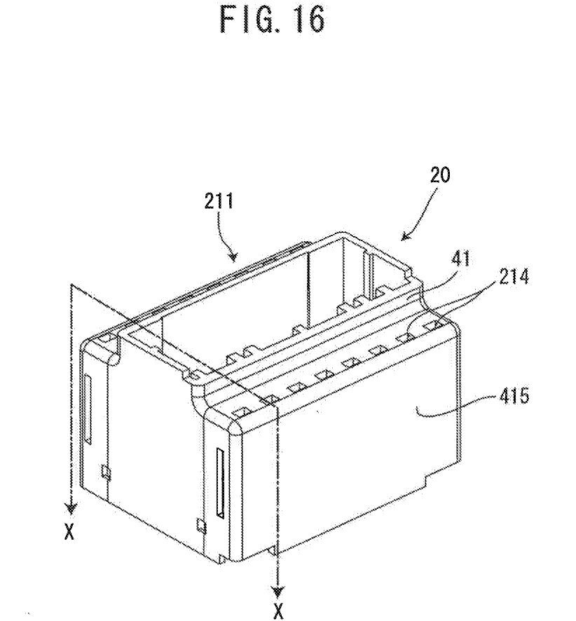

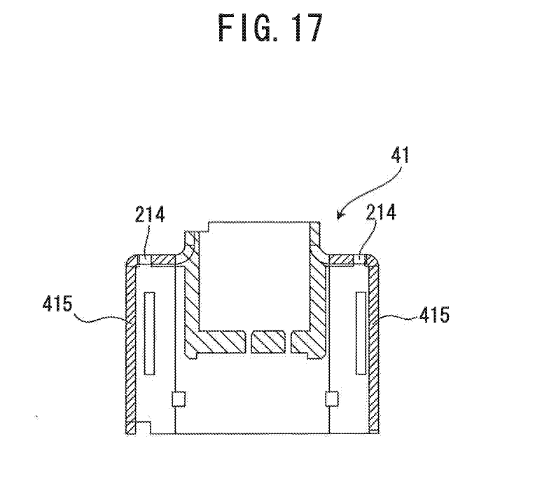

Now reference to FIGS. 14-17, another connector 40 according to the invention will be described, and is different from the connector 20 only with respect to a housing 41. For this reason, elements except for the different elements are denoted using the same reference signs as those used for the connector 20, and only differences from the connector 20 will be described.

The housing 41 includes partition walls 415 on both side surfaces thereof. The partition walls 415 form partial areas along the inner wall surfaces defining the circuit receiving space 213 in which the internal circuit 25 is positioned, and partial areas of outer surfaces defining an external appearance of the connector 30.

In the shown embodiment, the housing 41 is a two-color mold of first resin having insulation and low thermal conductivity and second resin having electrical conductivity and high thermal conductivity. The partition walls 415 are formed using the second resin that has the high thermal conductivity. A portion formed from the second resin may extend further from the partition walls 415. In fact, the second resin may extend as far as the insulation section that holds the first contacts 21 or the second contacts 22.

In the present embodiment, since the partition walls 415 are formed using the second resin having the high thermal conductivity, heat in the circuit receiving space 213 is dissipated via the ventilation openings 214, and also via the partition walls 415. For this reason, the heat in the circuit receiving space 213 is dissipated further effectively.

Although the exemplary embodiment of the invention has been disclosed for illustrative purposes, those skilled in the art will appreciate that various modifications, additions and substitutions are possible, without departing from the scope and spirit of the invention as disclosed in the accompanying claims.

What is claimed is:

1. An electrical connector comprising:
a housing having a mating section with a mating contact, a mounting section having a circuit board contact, and a circuit receiving space positioned along an inner surface thereof; and
an electronic circuit positioned in the circuit receiving space and connected to both of the mating contact and the circuit board contact, the electronic circuit having a photocoupler which electrically insulates the mating contact and the circuit board contact from each and passes an optical signal.

2. The electrical connector according to claim 1, wherein the electronic circuit connects to the mating contact and the circuit board contact through another circuit device.

3. The electrical connector according to claim 1, further comprising a ventilation opening disposed along and extending through the housing in communication with the electronic circuit.

4. The electrical connector according to claim 1, wherein the housing includes a first metal layer disposed along an outer surface thereof.

5. The electrical connector according to claim 4, further comprising a ventilation opening disposed along and extending through the housing in communication with the circuit receiving space and the first and second metal layers.

6. The electrical connector according to claim 4, wherein the housing includes a second metal layer disposed along an inner surface thereof.

7. The electrical connector according to claim 1, wherein the housing includes a body, a partition wall over the body, and the circuit receiving space is disposed between the body and the partition wall.

8. The electrical connector according to claim 7, wherein the partition wall is formed of a first molded resin having high thermal conductivity.

9. The electrical connector according to claim 8, wherein the body is formed of a second molded resin having low thermal conductivity.

10. The electrical connector according to claim 7, wherein the body includes a sidewall extending parallel with respect to the partition wall.

11. The electrical connector according to claim 10, wherein the photocoupler is mounted on a surface of the sidewall.
